(19) United States
(12) Patent Application Publication
(10) Pub. No.: US 2024/0396311 A1
(43) Pub. Date: Nov. 28, 2024

(54) FLEXIBLE CONNECTOR FOR RIGID CONDUIT AND INTEGRATED CHANNEL TO PULL WIRE

(71) Applicant: IDEAL Industries, Inc., Sycamore, IL (US)

(72) Inventor: Douglas A. Sanford, Naperville, IL (US)

(21) Appl. No.: 18/674,043

(22) Filed: May 24, 2024

Related U.S. Application Data
(60) Provisional application No. 63/468,662, filed on May 24, 2023.

(51) Int. Cl. H02G 3/04

(52) U.S. Cl. CPC H02G 3/0406; H02G 3/0462

(57) ABSTRACT

A device includes a flexible shaping body providing an open pathway to allow a flexible electrical conduit to shape and form into different positions. The device includes a first end of the flexible electrical conduit having a first connectable open pathway for connecting to a first rigid conduit. The device also includes a second end of the flexible electrical conduit having a second connectable open pathway for connecting to a second rigid conduit.

### CROSS REFERENCE TO RELATED APPLICATION

This application is a non-provisional application claiming priority from U.S. Provisional Application Ser. No. 63/468,662, filed May 24, 2023, the contents of which are incorporated herein by reference in their entirety.

### FIELD OF THE DISCLOSURE

The present description relates generally to rigid conduit and more particularly to a flexible connector for rigid conduit and an integrated channel to pull wire.

### BACKGROUND OF RELATED ART

Electrical conduit is commonly used in various types of buildings to protect electrical wiring that is routed throughout the structural framework of a building. Rigid metal conduit (“RMC”) is a hollow metal tube that is used to protect electrical wiring that is run through the hollow interior. A typical installation of the wires used to carry current, for example, in a commercial building, will be pulled through the RMC after the RMC has been routed throughout a building and clamped in place. Once the RMC is in place, it is usually very difficult to make changes in the wire configuration because the rigid metal pipe typically cannot be easily cut and reworked.

There has recently been an increasing use of flexible metal conduit construction for many new commercial buildings. Flexible metal conduit (“FMC” or “MC cable”, for instance) has insulated electrical wires pre-installed inside the flexible metal outer armor. MC cable is flexible in nature and allows the installer to bend the cable around various obstacles (i.e. heating and ventilation ducts, steel studs, support beams, etc.) that are in the way of running the wiring through the building walls. The MC cable does come with a higher cost due to the expense of added wiring into the complete cable at the onset. Making changes to the wiring is also complex since the whole cable will need to be reworked or replaced.

Given the two methods of installing and protecting the wiring in a metal outer jacket or conduit system, there is a novel method to allow flexible fittings (similar to the MC cable shape) being used with the solid conduit RMC pipe.

### BRIEF DESCRIPTION OF THE DRAWINGS

FIG. 1 is a right-side view of an example flexible connector for rigid conduit according to one or more aspects of the present disclosure.

FIG. 2 is another right-side view of the example flexible connector for rigid conduit of FIG. 1 showing the connector in one example of a manipulated configuration.

FIG. 3 is a perspective view of the example flexible connector for rigid conduit, showing the connector in another example manipulated configuration.

FIG. 4 is a perspective view of an example integrated channel to pull wire according to one or more aspects of the present disclosure.

FIG. 5 is a perspective view of another example integrated channel to pull wire according to one or more aspects of the present disclosure.

FIG. 6 is a perspective view of another example integrated channel to pull wire according to one or more aspects of the present disclosure.

### DETAILED DESCRIPTION

The following description of example methods and apparatus is not intended to limit the scope of the description to the precise form or forms detailed herein. Instead, the following description is intended to be illustrative so that others may follow its teachings.

More precisely, in at least one example, the following is a description of a flexible connector for rigid conduit. The present disclosure of the flexible connector for rigid conduits achieves at least some advantages over RMC, metal clad cables (MC cable), non-metallic cables, or the like. The flexible connector of the present disclosure is rigid or semi-rigid, and does not require additional mechanisms to set into place while also having a flexible shaping body to allow the flexible connector to take on various shapes and/or forms. The flexible shaping body is rigid enough to stay in a position after the flexible connector is formed or shaped into a position. The flexible connector of the present disclosure may also not have pre-installed, fixed conductors, such as wires or the like, allowing multiple electrical wires to be pulled through as needed. Further, the flexible shaping body of the flexible connector of the present disclosure allows more than one adjustment of the position of the flexible connector. The flexible connector of the present disclosure allows reshaping or reforming of the flexible connector with electrical wires already pulled through the flexible connector as well. The flexible connector of the present disclosure may be used anywhere rigid conduit is used.

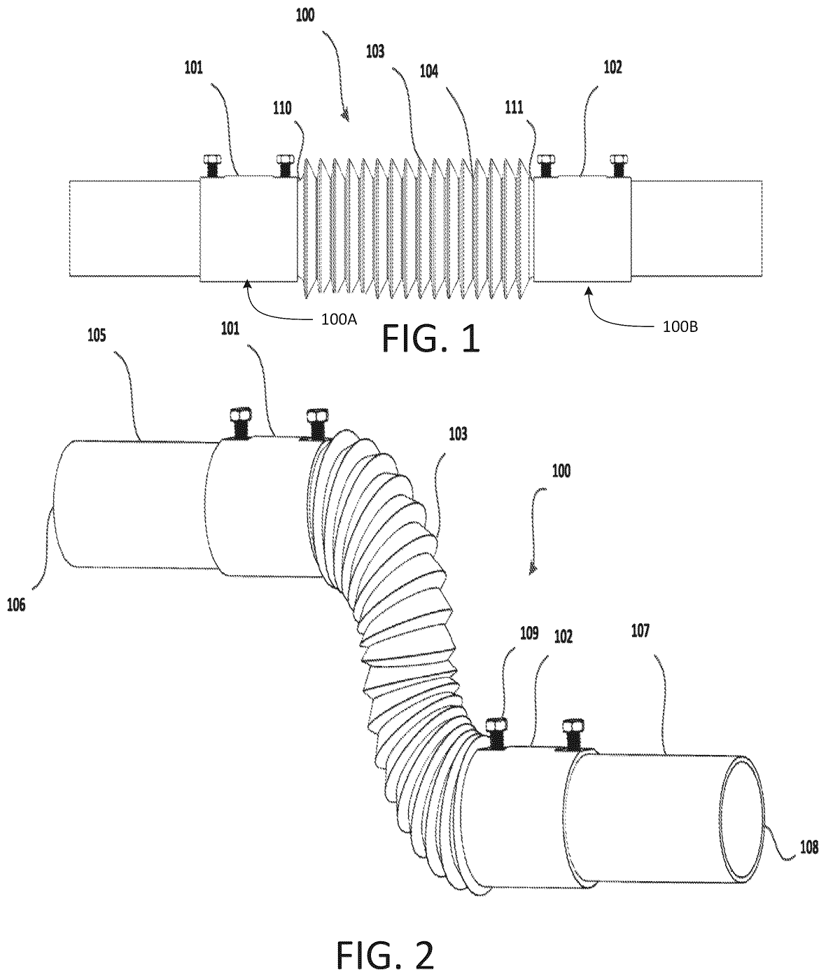

FIGS. 1-3 depict an example flexible connector 100 for rigid conduit according to one or more aspects of the present disclosure. Referring to the figures, the example flexible connector 100 comprises a first end 100A including a first connectable open pathway 101 and a second end 100B including a second connectable open pathway 102. A flexible shaping body 103 extends between the first end 100A and the second end 100B. In this example, the flexible shaping body 103 comprises a metal material, however it will be understood by one of ordinary skill in the art that the flexible shaping body 103 may include any suitable material. The example flexible shaping body 103 is a continuous open pathway that ends at the first connectable open pathway 101 and the second connectable open pathway 102. In this example, the continuous open pathway of the flexible shaping body 103 is insulated for conductive electrical conductors, such as wires (not shown). The electrical conductors, or wires, may be insulated or may alternatively be non-insulated as desired.

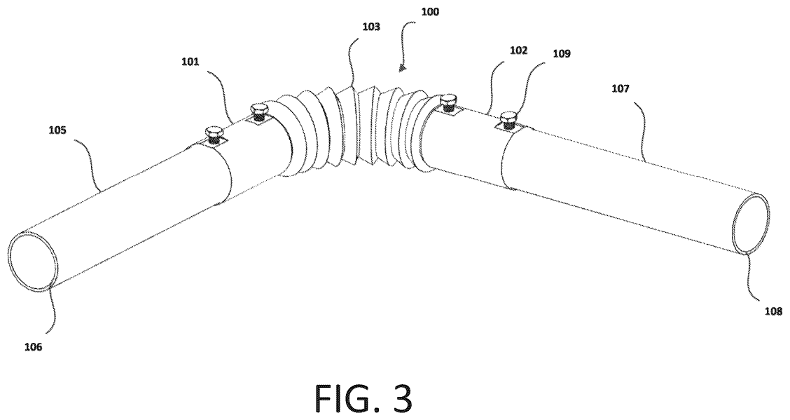

As illustrated, the example flexible shaping body 103 includes and/or is configured with a flexing feature 104. As detailed, the example flexing feature 104 of the flexible shaping body 103 allows the flexible connector 100 to shape and form into various positions. For instance, FIG. 1 illustrates that the flexible shaping body 103 may be a relative straight connection, while FIG. 2 illustrates that the flexible shaping body 103 may be moved and/or formed into a general S-shaped curve. Finally, FIG. 3 illustrates that the flexible shaping body 103 may be moved into an angular bend such as a ninety-degree bend. With the flexibility provided by the flexible shaping body 103, the overall shape of the flexible connector 100 may be any desirable shape. In some examples, the flexible shaping body 103 may be provided with limiters (not shown) that may limit the amount of bend or movement that the flexible shaping body 103 is allowed. For example, the flexible shaping body 103 may be prohibited from moving beyond a certain angle, for instance 90 degrees, to avoid any danger with the conductor(s) inserted within the flexible connector 100, such as breakage or pinches.

The flexing feature 104 may be of any suitable construction, including an accordion-type construction as illustrated. The illustrated accordion feature comprises a plurality of peaks and valleys with overlapping material in between. The peaks and valleys provide points of flexion and or pivot. Accordingly, the flexing feature 104 allow for bending and/or shaping of the flexible shaping body 103 while also allowing for expanding and contracting the overall length of the flexible shaping body 103. In other examples, the flexing feature 104 may be alternatively configured, such as for instance, the flexing feature 104 may comprise shingles, coiled material, variously spaced cuts in the flexible shaping body 103 surface, or other suitable constructions.

One function of RMC is to provide ground fault protection. Ground fault protection may be according to the National Electrical Code (NEC) standard or any other suitable code or standard. Accordingly, in addition to being configured as disclosed above, the flexing feature 104 may configured to always provide contiguous metal contact throughout the entire length of the flexible connector 100. For example, the flexible shaping body 103 may be fabricated of a single contiguous piece of metal, bend or formed into the accordion feature. In other examples, the flexible shaping body 103 may be configured to include always overlapping metal portions, conductors, or other suitable fabrication materials. In the example where the flexible shaping body 103 comprises a plurality of metal shingles, the shingles may be configured to always overlap and/or contact, such that there is formed a contiguous electrical path regardless of the end shape. In such a way, it is contemplated that the flexible shaping body 103 may have a flexible non-metallic hollow core for stability and shape maintenance, with a metal cladding (e.g., shingles) for ground fault protection.

As noted above, in the illustrated examples, the multiple indentations of the flexing feature 104 act in an accordion-like manner allowing the flexible shaping body 103 to extend, contract, shape, and/or otherwise form into different positions. The multiple indentations of the flexing feature 104 allow for step-wise gradients in the flexible shaping body 103 to stretch, form, or shape the flexible shaping body 103 into different positions. Additionally, the flexible shaping body 103 may be moved and moved again as needed with little to no structural integrity change, and may furthermore maintain its new position until further manipulated.

The example flexible shaping body 103 may be integrally (e.g., unitarily) formed with one or more of the first connectable open pathway 101 or the second connectable open pathway 102. Additionally, or alternatively, the flexible shaping body 103 may comprise a first flexible shaping body end 110 and a second flexible shaping body end 111 as illustrated herein. In this illustration, the first flexible shaping body end 110 and the second flexible shaping body end 111 are substantially smooth surfaced and rigid, and are attached to the first connectable open pathway 101 and/or the second connectable open pathway 102 (for example, in a manner described below).

As previously disclosed, the flexible shaping body 103 may be formed or any suitable material and/or combination of materials as desired. For instance, in another example of the present disclosure, the flexible shaping body 103 of the flexible connector 100 may be made of malleable or deformable metal to allow for shaping and forming the flexible shaping body 103.

In another example of the present disclosure, the flexible shaping body 103 meets electrical metal tubing (EMT) requirements for electrical code.

In another example of the present disclosure, the flexible shaping body 103 may be configured to allow a limited number of times to shape or form the flexible shaping body 103 before the flexible shaping body 103 is no longer malleable. Alternatively, the flexible shaping body 103 may be configured to be indefinitely flexible (e.g., until failure).

In still another example of the present disclosure, conductive electrical wires or other suitable conductor may be run through the continuous open pathway of the flexible shaping body 103 before the flexible shaping body 103 is shaped or formed into position. The flexible shaping body 103 may be shaped or formed into a different position than the initial position it is shaped or formed into with conductive electrical wires already installed into the flexible connector 100.

In another example of the present disclosure, the flexible shaping body 103 may be shaped or formed by hand and/or but not limited to other tools or specialty tools for shaping and forming.

Referring specifically to FIGS. 2 and 3 depict examples of the flexible connector 100 according to one or more aspects of the present disclosure. As shown, the flexible connector 100 may be attached or connected to a first rigid conduit 105 and/or a second rigid conduit 107. The first rigid conduit 105 may include an inner open pathway 106. The second rigid conduit 107 may include an inner open pathway 108. The first end 100A, including the first connectable open pathway 101 of the flexible connector 100, may be attached, mounted, or connected to the first rigid conduit 105. Similarly, the second end 100B, including the second connectable open pathway 102 of the flexible connector 100, may be attached, mounted, or connected to the second rigid conduit 107.

Each of the first connectable open pathway 101 and the second connectable open pathway 102 may be connected at a first end to a respective one of the first rigid conduit 105 or the second rigid conduit 107 and at a second end to the flexible shaping body 103 (e.g., at the first flexible shaping body end 110 and the second flexible shaping body end 111 not shown in FIGS. 2 and 3). Various methods of connection are contemplated. For example, one or more of the first connectable open pathway 101 and the second connectable open pathway 102 may comprise one or more set screws 109. The set screws may be tightened, through the first connectable open pathway 101 and the second connectable open pathway 102, against the underlying one of the first rigid conduit 105 or the second rigid conduit 107, and/or the first flexible shaping body end 110 or the second flexible shaping body end 111. Additionally or alternatively, other methods of connection may be used. For example, one or more of the first connectable open pathway 101 and the second connectable open pathway 102 may be welded, clamped, or otherwise attached to a respective one of the first rigid conduit 105 or the second rigid conduit 107, and/or the first flexible shaping body end 110 or the second flexible shaping body end 111. Additionally or alternatively, one or more of the first connectable open pathway 101 and the second connectable open pathway 102 (e.g., at an internal surface) may be threaded, and a respective one of the first rigid conduit 105 or the second rigid conduit 107 (e.g., at an external surface), and/or the first flexible shaping body end 110 and the second flexible shaping body end 111 may be correspondingly threaded, and the elements may be threaded together.

Although depicted in FIGS. 2 and 3 as comprising two ends, the flexible connector 100 is not so limited and may be variously shaped and configured. For example, the flexible connector 100 may be substantially Y-shaped, X-shaped, or any other shape having any number of ends (e.g., openings). According to such configurations, the flexible connector 100 may have any number of ends attached to any number of rigid conduits.

In one embodiment of the present disclosure, the flexible connector 100 may be shaped or formed into a different position than its initial position while it is connected to a first rigid conduit 105 and a second rigid conduit 107. This may make modifications to the flexible connector 100 easier so the connected one of the first rigid conduit 105 and the second rigid conduit 107 do not have to be discarded when a modification of the flexible shaping body 103 is needed.

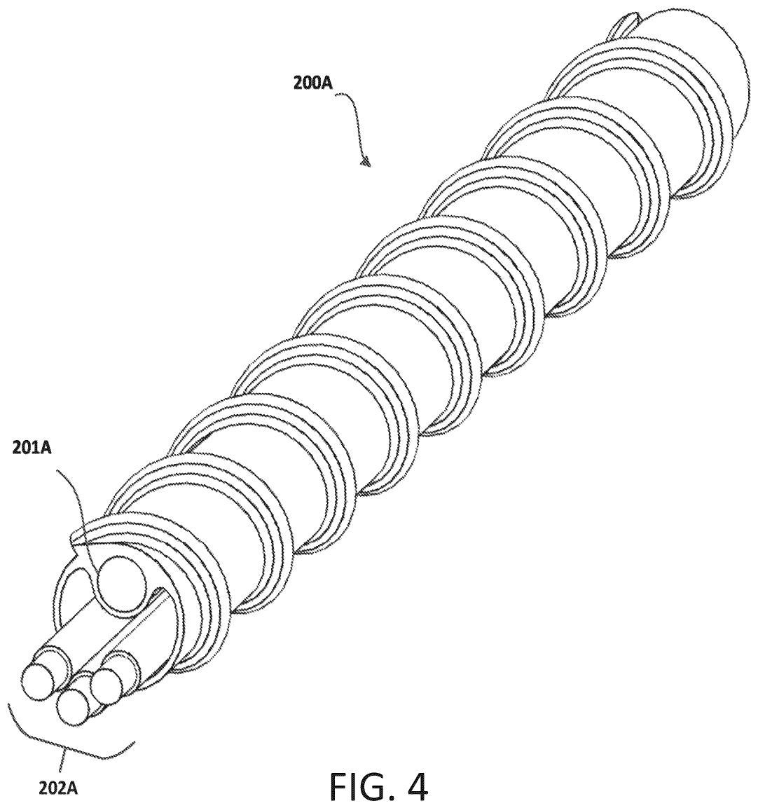

Referring now to FIGS. 4-6, the following is a description of an integrated channel to pull wire. Currently, metal clad cables (MC) cable and non-metallic cables (NM) cable come with pre-installed electrical wires and do not allow for other electrical wires to be pulled through the cable. In particular, the metal clad cables and non-metallic cables have tight channels with a fixed number of wires. With no additional channel or opening for the pulling through of additional wires, difficulties arise when the fixed, electrical wires need modification. The modification of metal clad cables and non-metallic cables installed throughout the framework of a building often requires burdensome deconstruction of the building, such as tearing down walls or other structures of the building. Also, with no channel for additional wires to run through metal clad cables and non-metallic cables, there is no option for simply adding more electrical wires through the cables when needed, and often requires a separate cable. After metal clad or non-metallic wires are installed, the ability to pull wires does not exist or is extremely difficult.

The present disclosure provides a clear advantage over current metal clad and non-metallic cables. The present disclosure allows for an integrated channel to pull wire through metal clad or non-metallic cables. The integrated channel to pull wire through is made during the extruding, molding process, or fabrication process of the metal clad or non-metallic cables. The channel could be integrated, inserted, or attached to pre-wired metal clad cables or nonmetallic cables. The channel may take on various shapes, such as a circular shape, a rectangular shape, a diamond shape, etc. but is not limited to such examples. The channel may be rigid to prevent crimpling or narrowing of the channel.

FIG. 4 depicts an example of an integrated channel to pull wire according to one or more aspects of the present disclosure. Referring to FIG. 4, a metal clad cable 200A includes an integrated channel to pull wire 201A and at least one pre-installed wire 202A. The example integrated channel to pull wire 201A comprises a continuous open pathway or tube that, for example, may allow for the pulling through of electrical wires after the metal clad cable 200A is installed into the structural framework of a building or elsewhere.

The metal clad cable 200A comprises, for example, MC cable as described above. For instance, the example metal clad cable 200A comprise a flexible metal conduit having a helical metal outer jacket. The metal clad cable 200A may be utilized to protect insulated metal wires. Accordingly, it is presently contemplated to produce such MC cable with an open pathway such that, inter alia, wires, conductors, cables, or other suitable material may be pulled through the open pathway after MC cable installation.

An integrated channel to pull wire is contemplated for various wire/cable configurations. In particular, FIG. 5 depicts another example of an integrated channel to pull wire according to one or more aspects of the present disclosure. Referring to FIG. 5, a non-metallic sheathed wire 200B includes an integrated channel to pull wire 201B and at least one pre-installed wire 202B. The example integrated channel to pull wire 201B comprises a continuous open pathway or tube that allows for the pulling through of electrical wires, for example, after the non-metallic sheathed wire 200B is installed into the structural framework of a building or elsewhere.

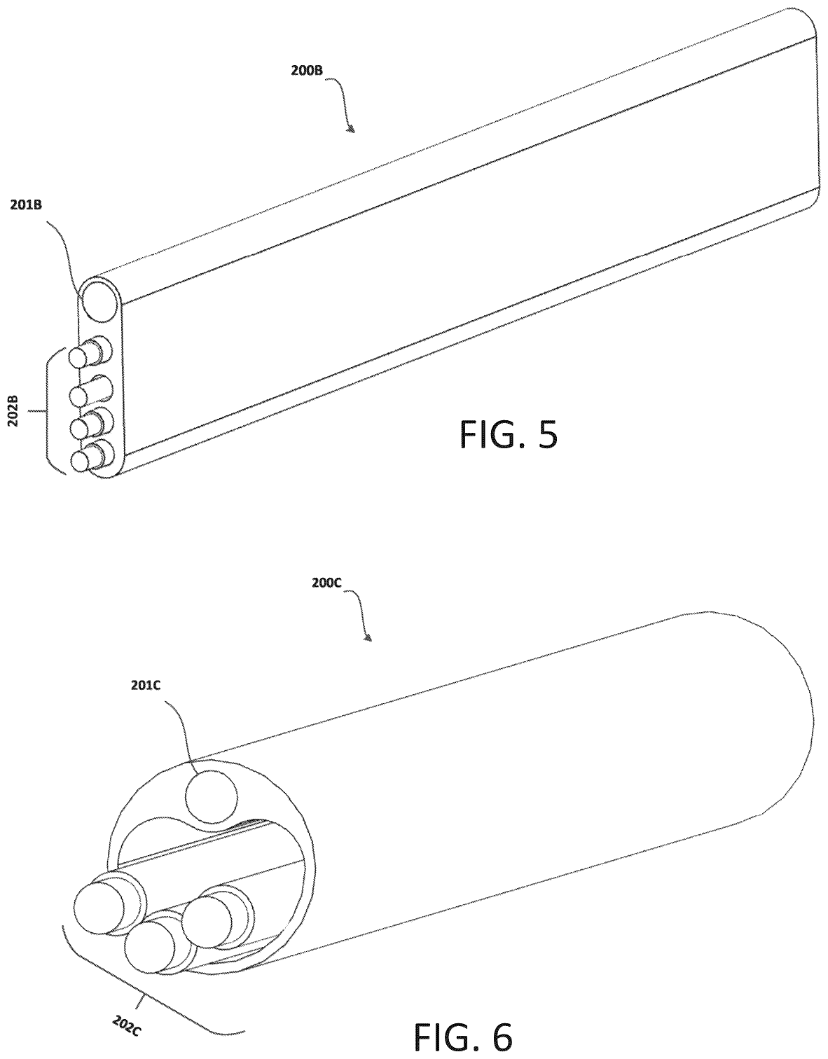

Still further, FIG. 6 depicts another example of an integrated channel to pull wire according to one or more aspects of the present disclosure. Referring to FIG. 6, a non-metallic sheathed wire 200C includes an integrated channel to pull wire 201C and at least one pre-installed wire 202C. The instant integrated channel to pull wire 201C comprise a continuous open pathway or tube that may allow for the pulling through of electrical wires, for example, after the non-metallic sheathed wire 200C is installed into the structural framework of a building or elsewhere.

As may be appreciated with reference to FIGS. 5-6, the non-metallic sheathed wire 200B and the non-metallic sheathed wire 200C may be of any suitable shape. For example, with reference to FIG. 5, the nonmetallic sheathed wire 200B may have a substantially oblong cross-section. Alternatively, with reference to FIG. 6, the non-metallic sheathed wire 200C may comprise a substantially round cross-section. Any other shaped cross-section wire is contemplated herein.

In one example of the present disclosure, the continuous open pathway or tube of the integrated channel to pull wire may be formed with lubricated material to allow for easy pulling through of electrical wires.

In another example of the present disclosure, the continuous open pathway or tube of the integrated channel to pull wire may have an outer diameter with an outer tubing and an inner diameter with an inner tubing to help keep the integrated channel from collapsing on itself or being crimped or narrowed.

In another example of the present disclosure, the integrated channel to pull wire may be in the shape of, but is not limited to, a rectangle, diamond, circle and/or other shapes.

In still another example of the present disclosure, the integrated channel to pull wire through may have a dedicated opening in the continuous open pathway or tube to allow the pulling of wire through the integrated channel.

In another example of the present disclosure, fish tape or a pre-installed pulling device (i.e. string, plastic line) may be used to pull wires through the continuous open pathway or tube of the integrated channel to pull wire after the metal clad cable 200A, the non-metallic sheathed wire 200B, or the wire non-metallic sheathed wire 200C are installed, for example, into the structural framework of a building or elsewhere.

Finally, in yet another example of the present disclosure, stranded, solid electrical wires, and/or cables may be pulled through the continuous open pathway or tube of the integrated channel to pull wire.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. A flexible electrical conduit, comprising:
a flexible shaping body providing an open pathway to allow a flexible electrical conduit to shape and form into different positions;
a first end of the flexible electrical conduit including a first connectable open pathway for connecting to a first rigid conduit; and
a second end of the flexible electrical conduit including a second connectable open pathway for connecting to a second rigid conduit.

2. The flexible electrical conduit of claim 1, wherein the flexible shaping body is a continuous, open pathway including indentations along the surface of the flexible shaping body.

3. The flexible electrical conduit of claim 2, wherein the indentations along the surface of the flexible shaping body are configured to allow the flexible electrical conduit to shape and form into different positions.

4. The flexible electrical conduit of claim 1, wherein the flexible shaping body is no longer malleable after a threshold number of times of being shaped or formed.

5. The flexible electrical conduit of claim 1, wherein the flexible shaping body comprises an accordion-like surface capable of extending and contracting in length.

6. The flexible electrical conduit of claim 1, wherein the first connectable open path way is rigidly mountable to the first rigid conduit.

7. The flexible electrical conduit of claim 6, wherein the first connectable open pathway is rigidly mountable to the first rigid conduit by a set screw.

8. The flexible electrical conduit of claim 1, wherein the second connectable open pathway is rigidly mountable to the second rigid conduit.

9. The flexible electrical conduit of claim 8, wherein the second connectable open pathway is rigidly mountable to the second rigid conduit by a set screw.

10. The flexible electrical conduit of claim 1, wherein each of the flexible shaping body, the first end, and the second end is metal.

11. The flexible electrical conduit of claim 10, further comprising an insulating body disposed between the open pathway and the flexible shaping body.

12. An electrical conduit, comprising:
a first rigid portion comprising an inner open pathway;
a second rigid portion comprising an inner open pathway; and
a flexible portion forming a continuous open pathway between the first rigid portion and the second rigid portion, a first end including a first connectable open pathway, and a second end including a second connectable open pathway.

13. The electrical conduit of claim 5, wherein the indentations along the surface of the flexible portion are configured to allow the flexible portion to shape and form into different positions.

14. The electrical conduit of claim 5, wherein the flexible portion remains rigid once shaped or formed into a position.

15. The electrical conduit of claim 5, wherein the first inner open pathway of the first rigid portion is connected to the first connectable open pathway of the first end of the flexible portion, and the second inner open pathway of the second rigid portion is connected to the second connectable open pathway of the second end of the flexible portion.

16. A metal clad cable comprising:
a fixed channel including pre-installed electrical wires; and
an integrated channel configured to permit pulling through of electrical wires including a first end, a second end, and an opening between the first end and the second end for pulling electrical wires through the integrated channel.

17. A non-metallic sheathed wire comprising:
a fixed channel including pre-installed electrical wires; and
an integrated channel configured to permit pulling through electrical wires including a first end, a second end, and a pulling device for pulling electrical wires through the integrated channel.

18. The non-metallic sheathed wire of claim 17, wherein the pulling device is fish tape or a string running a length of the integrated channel.
